(19) United States
(12) Patent Application Publication
(10) Pub. No.: US 2008/0066814 A1
(43) Pub. Date: Mar. 20, 2008

(54) Two-Stage Servo-Valve

(76) Inventor: Andre-Heinrich Meinhof, Rheinstetten (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/664,740

(22) PCT Filed: Oct. 5, 2005
(86) PCT No.: PCT/EP05/55030

§ 371 Date: Apr. 5, 2007

(30) Foreign Application Priority Data
Oct. 6, 2004 (DE) 10 2004 048 689.1

(51) Int. Cl. F15B 13/043

(52) U.S. Cl. 137/625.64

(57) ABSTRACT

A two-stage servo-valve has a first stage in which four flow resistances are arranged in a bridge circuit. At least one of the flow resistances is variable, and two opposite switching points of the bridge circuit are connected to an air inlet and to an air outlet respectively. A differential pressure of variable size and sign is provided between the two other switching points. The servo-valve also has a second stage in which a control piston which can be actuated by the differential pressure is arranged and controls a three-way valve. In order to enable the current position of a process valve driven by the servo-valve to be maintained by the most simple means in the event of a power failure, the switching points which provide the differential pressure are interconnected by a magnetic valve which is closed in the driven state and open in the unconnected state, thus pneumatically interconnecting the switching points.

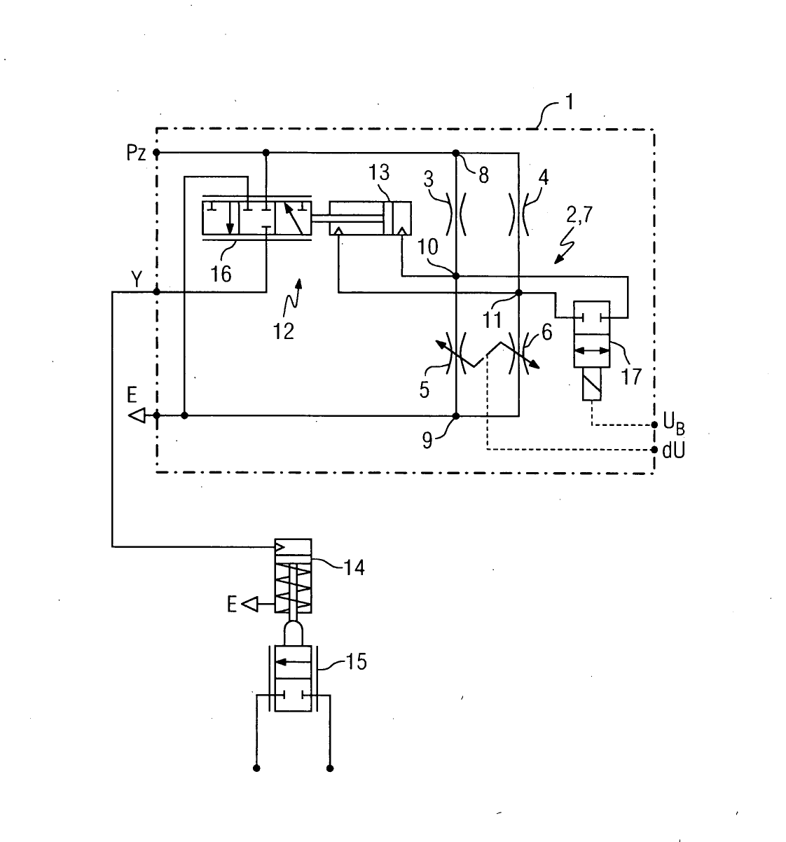

### CROSS REFERENCE TO RELATED APPLICATIONS

This application is the US National Stage of International Application No. PCT/EP2005/055030, filed Oct. 5, 2005 and claims the benefit thereof. The International Application claims the benefits of German application No. 10 2004 048 689.1 DE filed Oct. 6, 2004, both of the applications are incorporated by reference herein in their entirety.

### FIELD OF INVENTION

The invention relates to a two-stage servo-valve having a first stage in which four flow resistances are arranged in a bridge circuit, at least one flow resistance of which is variable and two opposite switching points of the bridge circuit are connected to an air inlet and to an air outlet and a differential pressure of variable size and sign is provided between the two other switching points. The servo-valve also has a second stage in which a control piston which can be actuated by the differential pressure is arranged and controls a three-way valve.

### BACKGROUND OF INVENTION

A servo-valve of this type and known from DE 41 35 822 A1 contains up to four individual piezo-valves in a first stage, all four piezo-valves, or in the case of a lower number together with fixed resistances, being arranged in a bridge circuit. Each piezo-valve contains its own actuatable piezo-element, which, together with a deflector, forms a controllable flow resistance. The bridge circuit serves to generate a differential pressure of variable size and sign, with which, in a further stage of the servo-valve, a control piston can be adjusted and a three-way valve can be adjusted by way of said control piston, said three-way valve serving to adjust a hydraulic cylinder.

Alternative designs of piezo-valves are known from EP 0 943 812 A1 or the subject matter of the former German patent application with the official file reference 10

Instead of piezo-valves, electromagnetic or any other electrically actuatable valves can also be used in the bridge circuit.

DE 42 01 442 A1 shows an alternative embodiment of the three-way valve, which, in a known manner, can also be configured as a slide valve, rotary valve or can consist of individual valves such as for instance check valves.

Servo-valves are used in many areas of technology, thus also with electro-pneumatic positioners, which serve to control the drive of process valves. In the event of a power failure, a request is often made for the drive actuated by the positioner to automatically bring the process valve into a secure position, generally “open” or “close”.

### SUMMARY OF INVENTION

An object underlying the invention is to enable the current position of the process valve driven by the servo-valve to be maintained using the simplest means in the event of a power failure.

In accordance with the invention, the object is achieved in that in the case of the servo-valve of the type specified at the start, the switching points providing the differential pressure are interconnected by way of a magnetic valve, said magnetic valve being closed in the driven state and open in the unconnected state, thus pneumatically interconnecting the switching points.

In the event of a power failure, the magnetic valve opens and thus briefly pneumatically closes the exit of the bridge circuit and/or the two hydraulic sides of the control piston. As a consequence, the three-way valve adopts the center position (rest position), which enables the process valve drive which can be connected thereto to be maintained in the current position. Furthermore, the servo-valve according to the invention is described with reference to one of the exemplary embodiments illustrated in the sole FIGURE of the drawings.

### BRIEF DESCRIPTION OF THE DRAWING

A sole FIGURE shows an example of a two-stage servo-valve.

### DETAILED DESCRIPTION OF INVENTION

In a first stage 2, the two-stage servo-valve 1 contains four flow resistances 3,4,5,6 which are arranged in a bridge circuit 7. The flow resistances 5 and 6 are designed as piezo-valves and are inversely variable by means of an electrical control voltage dU. The bridge circuit 7 is connected to an air inlet Pz and/or to an air outlet E at two opposite switching points 8, 9. A differential pressure of variable size and sign is provided at both other switching points 10 and 11. This differential pressure allows a control piston 13 arranged in a second stage 12 of the servo-valve 1 to be displaced, said control piston controlling a three-way valve 16 interposed between the air inlet and air outlet Pz, E and the drive 14 of a process valve 15. At both end positions of the three-way valve 16, the drive 14 is either connected to the air inlet Pz or to the air outlet E and thus shifts the process valve 15 to “close” or “open”. In the center position (rest position) of the three-way valve 16, the drive 14 is separated from the air inlet and/or air outlet Pz E, and remains in the current position in each instance.

To ensure that the three-way valve 16 adopts the center position in the event of a power failure, and thus maintains the drive 14 and/or the process valve 15 in the current position, a magnetic valve 17 is arranged between the switching points 10 and 11 of the bridge circuit 7, said magnetic valve 17 being driven by the operating voltage U B and in this way being closed. In the event of an operating voltage failure, the magnetic valve 17 opens and in this way briefly pneumatically closes the switching points 10 and 11. As a consequence, the three-way valve 16 adopts its center position. The piezo valves 5, 6 and the three-way valve 16 can be embodied differently, as can be inferred for instance from the publications mentioned in the introductory part of the specification.

1. (canceled)

2. A Two-stage servo-valve, comprising:
a first stage having:
four flow resistances arranged in a bridge circuit, wherein at least one flow resistance is a variable flow resistance,
a first pair of switching points for the bridge circuit, wherein one switching point of the first pair of switching points is connected to an air inlet and the other switching point of the first pair of switching points is connected to an air outlet,
a second pair of switching points for the bridge circuit providing a differential pressure and pneumatically connected to one another via a magnetic valve being closed in a driven state and being open in an unconnected state;
a second stage, having a control piston actuated based upon a differential pressure between a second pair of opposite switching points; and
a three-way valve controlled via the control piston.

3. The two-stage servo valve as claimed in claim 2, wherein the switching points of the first pair of switching points are opposite to each other.

4. The two-stage servo valve as claimed in claim 2, wherein the differential pressure between the second pair of opposite switching points is of variable size and sign.

5. A Two-stage servo-valve, comprising:
a first stage having a bridge circuit, the bridge circuit having:
a first branch with a plurality of flow resistances,
a second branch with a plurality of flow resistances, wherein at least one flow resistance is variable, and
a bridge having a control piston and in parallel a magnetic valve,
a pair of switching points connected to an inlet and to an outlet; and
a second stage, having a three-way valve controlled via the control piston.

6. The two-stage servo valve as claimed in claim 5, wherein the magnetic valve is closed in a driven state and open in an unconnected state.

7. The two-stage servo valve as claimed in claim 6, wherein the two-stage servo valve is a pneumatic valve.
